(19) United States
(12) Patent Application Publication
(10) Pub. No.: US 2008/0016751 A1
(43) Pub. Date: Jan. 24, 2008

(54) Rodent trap with calming agent

(76) Inventor: Steven Frisch, Brooklyn, NY (US)

Correspondence Address: Bernard Malina, Esq.,;MALINA & ASSOCIATES, PLLC, Suite 501, 60 East 42nd Street, New York, NY, 10165, US

(21) Appl. No.: 11/880,175

(22) Filed: Jul. 20, 2007

Related U.S. Application Data
(60) Provisional application No. 60/807,851, filed on Jul. 20, 2006.

(51) Int. Cl. A01M 99/00; A01M 23/00

(52) U.S. Cl. 43/58

(57) ABSTRACT

A rodent trap is provided as well as a method for more humanely trapping the rodent. The trapping device allows the rodent to enter or step onto a receiving area. A bait held within or on the device includes a natural herbal substance in an effective amount to operate as a calming agent to relax the rodent. Most preferred as a calming agent is Valerian Root.

### PRIOR APPLICATION

This application claims priority from Provisional Patent Application Ser. No. 60/807,851 entitled “Rodent Glue Trap With Calming Agent” filed Jul. 20, 2006.

### BACKGROUND OF THE INVENTION

1. Field of the Invention

The invention concerns a trap for rodents including rats and mice, wherein suffering of the rodent is reduced during its captive period.

2. The Related Art

Rodents, including mice and rats, often inhabit areas where they are unwanted. They become pests when they enter our homes, our stores, and our workplaces, often causing property damage and breeding disease.

Advances have occurred in the capture of rodents. Devices have improved in their efficiency. Live capture systems have been developed. Although rodent management is essential for public health, it should be done in as humane a manner as possible.

Classic to rodent capture is the snap trap. This device is a baited powerful spring which upon being tripped snaps to snare the animal. Most often, it is an instant killing. Less lethal are the glue traps. The rodent is caught and can suffer death or release. Although glue traps offer a safe and nontoxic alternative to other trapping methods, there are those who feel that the devices need improvement to diminish potential suffering. A third and most advanced device is the Live Catch. It is a cage with a one-way swinging door. The rodent enters but cannot leave. The capture person can then transport the occupied cage to a distant location and release its occupant. Even here, the animal may have undergone some trauma in seeking to escape.

The present disclosure also provides a method for more humanely trapping a rodent. This method involves setting a trapping device, capturing the rodent with the trapping device, and then disposing or releasing the animal. The trapping device will have a receiving area and a bait held within or on the device. This bait will include a natural herbal substance in an effective amount to operate as a calming agent to relax the rodent. Typical traps include a flat paper release glue board or sheet (“Glue Boards”) and glue trays described in U.S. Pat. No. 4,438,584 (Baker et al), herein incorporated by reference.

Besides the progressive improvement in trapping devices, there have been some proposals to address the trauma issue. U.S. Pat. No. 4,805,340 (Becker et al.) discloses a glue trap baited with Carbromal reported to have a calming effect upon the animal. A potential problem with Carbromal is its unknown effect upon the environment. Mass use of Carbromal in traps may have some unintended consequences. Indeed, this same criticism is appropriate to all synthetic chemicals. We may solve one problem but engender another. New inventive approaches are necessary.

### SUMMARY OF THE INVENTION

A rodent trap is provided which includes:
a trapping device allowing the rodent to enter or step onto a receiving area;
a bait held within or on the device including a natural herbal substance in an effective amount to operate as a calming agent to relax the rodent.

Further, a method is provided for more humanely trapping a rodent which includes:
setting a trapping device, the device allowing the rodent to enter or step onto a receiving area; and
a bait held within or on the device including a natural herbal substance in an effective amount to operate as a calming agent to relax the rodent;
capturing the rodent within the trapping device; and
disposing or releasing the trapped rodent.

### DETAILED DESCRIPTION OF THE INVENTION

Now it has been found that rodent torment can be minimized by providing a trapping device with a sedative or calming agent based upon a natural herbal substance. The substance will be present in an effective amount to operate as a sedative to relax the rodent. Some substances may have the additional benefit of being an attractant (e.g., pheromone) to the animal. Suitable natural herbal substances include the following:

Avena sativa (Milky oat seed);

Cimicifuga racemosa (Black Cohosh);

Eschscholzia californica (California Wild Poppy);

Humulus lupulus (Hops strobiles);

Lactuca virosa (Wild Lettuce);

Lavandula officinalis (Lavander);

Leonurus cardiaca (Motherwort);

Matricaria recutita (Chamomile, German);

Melissa officinalis (Lemon Balm);

Nepeta cataria (Catnip);

Passiflora incarnata (Passionflower);

Pedicularis spp. (Louseworts);

Piper methysticum (Kava kava);

Piscidia erythrena (Jamaican Dogwood);

Scutellaria spp. (Skullcap);

Stachys betonica (Betony);

Valeriana officinalis (Valerian root);

Verbena officinalis (Vervain);

Withania somnifera (Ashwaganda) and mixtures thereof.

Preferred of all the substances is Valerian Root. This substance sedates and also attracts rodents.

The bait may include anywhere from 0.0001 to 100% by weight of the natural herbal substance. Preferably, the amount may range from about 0.1 to about 80%, more preferably from about 3 to about 50% by weight of the bait.

The natural herbal substance can be present as an extract or in pulverized form. When present as an extract, the active herbal substance may be dissolved in a solvent such as water or alcohol. When the herbal substance is a solid, it may be pulverized plant components that include leaves, roots, stem and mixtures thereof. Typical pulverization will provide an average particle size ranging from about 1 micron to 2 mm.

Bait may be in pelletized form. These pellets may be round, cylindrical, plate-like, square, rectangular or any other attractive shape. Although size is not critical, the pellets may have an average diameter ranging from about 0.01 to about 1 inch, preferably from about 0.1 to about 0.5 inches. Thickness may vary from about 0.01 to about 1 inch, preferably from about 0.1 to about 0.5 inches. The pellets may be colored, texturized and/or provided with a scent to attract rodents or for aesthetic human purposes. Preferably, the pellets will include a binder to ensure integrity of the pulverized plant components. Gel form is a useful pellet structure. A particularly preferred pellet composition includes 99.995% ground Valerian Root and as binder, 0.005% magnesium stearate. Approximately 2 pellets are provided on each Glue Board or glue tray in the receiving area.

Binders may be any food or non-food substance. Typically, the binder may be a fatty acid or salt thereof, polysaccharide, a sugar, a gum and mixtures thereof. Amounts of the binder may range from about 0.0001 to 98% by weight of the bait.

The term “calming agent” is intended to mean any natural herbal substance that functions to either sedate, relax, tranquilize, hypnotize and/or anesthetize a rodent. The term “rodent” refers to rats, mice, and related mammals. The term “glue trap” is intended to mean any configuration of a trap for rodents that at least partially relies on an adhesive to function as a catch mechanism. Glues may be natural or synthetic. Illustrative but non-limiting examples of glue include starches, silicones, elastomers and polyvinyl acetate. More particularly, it is desirable to have an adhesive of a bond strength sufficient to temporarily trap the rodent but with insufficient strength so that the rodent, through human intervention, can easily be released.

Trapping devices according to the present invention may be a non-release glue trap, an easy release glue trap (e.g., only a thin layer of adhesive) or a Live Catch-Cage (with a one-way swinging door).

The preferred trapping devices are glue traps. The flat paper release trap is formed of a flat board or sheet with a central receiving area (“Glue Board”). A layer of adhesive is deposited onto the receiving area in an amount for sufficient strength to entrap the rodent. The flat sheet may be formed of a cellulosic (e.g., a cardboard), a plastic (e.g., polyethylene) or even metal. A release paper is sized to fit and is arranged over the entire adhesive layer on the receiving area. The release paper should be easily peelable when seeking to activate the trap.

Glue tray traps are described in U.S. Pat. No. 4,438,584 (Baker et al.) herein incorporated by reference.

In both the Glue Board and glue tray traps, bait in the form of pellets are randomly sprinkled across a surface of adhesive.

The present invention has been described with reference to certain preferred embodiments. Modifications and alterations will occur to those skilled in the art upon reading and understanding of the specification. It is intended to include all such modifications and alterations insofar as they come within the scope of the appended claims or the equivalents thereof.

What is claimed is:

1. A rodent trap comprising:
a trapping device allowing the rodent to enter or step onto a receiving area;
a bait held within or on the device comprising a natural herbal substance in an effective amount to operate as a calming agent to relax the rodent.

2. The rodent trap according to claim 1 wherein the natural herbal substance is a plant material selected from the group consisting of:
Avena sativa (Milky oat seed);
Cimicifuga racemosa (Black Cohosh);
Eschscholzia californica (California Wild Poppy);
Humulus lupulus (Hops strobiles);
Lactuca virosa (Wild Lettuce);
Lavandula officinalis (Lavander);
Leonurus cardiaca (Motherwort);
Matricaria recutita (Chamomile, German);
Melissa officinalis (Lemon Balm);
Nepeta cataria (Catnip);
Passiflora incarnata (Passionflower);
Pedicularis spp. (Louseworts);
Piper methysticum (Kava kava);
Piscidia erythrena (Jamaican Dogwood);
Scutellaria spp. (Skullcap);
Stachys betonica (Betony);
Valeriana officinalis (Valerian root);
Verbena officinalis (Vervain);
Withania somnifera (Ashwaganda) and mixtures thereof.

3. The rodent trap according to claim 1 wherein the natural herbal substance is Valerian Root.

4. The rodent trap according to claim 1 wherein the bait further comprises a binder.

5. The rodent trap according to claim 4 wherein the binder is present in an amount from 1 to 98% by weight of the bait.

6. The rodent trap according to claim 1 wherein the herbal substance comprises pulverized plant components selected from the group consisting of leaves, roots, stem and mixtures thereof.

7. The rodent trap according to claim 6 wherein the pulverized plant components have an average particle size ranging from 1 micron to 2 mm.

8. The rodent trap according to claim 4 wherein the binder is formed of a material selected from the group consisting of polysaccharide, a sugar, a gum and mixtures thereof.

9. The rodent trap according to claim 1 wherein the trapping device is a glue trap.

10. The rodent trap according to claim 9 wherein the receiving area of the glue trap comprises a flat board upon which is deposited a layer of adhesive sufficient in strength to entrap the rodent.

11. The rodent trap according to claim 10 wherein the bait is arranged above the adhesive layer as a series of pellets.

12. The rodent trap according to claim 1 wherein the bait is present in pelletized form.

13. The rodent trap according to claim 11 further comprising a release paper sized to fit and arranged entirely over the adhesive layer.

14. A method for more humanely trapping a rodent comprising:
(i) setting a trapping device, the device allowing the rodent to enter or step onto a receiving area, and a bait held within or on the device comprising a natural herbal substance in an effective amount to operate as a calming agent to relax the rodent;
(ii) capturing the rodent with the trapping device; and
(iii) disposing or releasing the rodent.
